(19) United States
(12) Patent Application Publication
(10) Pub. No.: US 2010/0272623 A1
(43) Pub. Date: Oct. 28, 2010

(54) AMBIENT TEMPERATURE LIQUID AMMONIA PROCESS FOR THE MANUFACTURE OF AMMONIA BORANE

(75) Inventors: Alexander LUKACS, III, Wayne, PA (US); Leonard Macadams, Sewell, NJ (US); Kevin Christmas, Deptford, NJ (US)

Correspondence Address: SIMPSON & SIMPSON, PLLC, 5555 MAIN STREET, WILLIAMSVILLE, NY, 14221-5406, US

(73) Assignee: K-Energetics Corp., Great Neck, NY (US)

(21) Appl. No.: 12/763,618

(22) Filed: Apr. 20, 2010

Related U.S. Application Data
(60) Provisional application No. 61/171,677, filed on Apr. 22, 2009.

(51) Int. Cl. C01B 35/14; C07F 5/02

(52) U.S. Cl. 423/285; 564/8

(57) ABSTRACT

A method of preparing an ammonia borane compound selected from the group consisting of: ammonia borane, ammonia alkyl borane, ammonia aryl borane and mixtures thereof, the method including the steps of: a) incorporating a reaction mixture into a pressure vessel, the reaction mixture including anhydrous liquid ammonia and a boron containing compound that can react under pressure with the liquid ammonia to form the ammonia borane compound; and, b) causing the reaction mixture to warm from a first temperature greater than or equal to −33° C. to a second temperature under pressure to form the ammonia borane compound.

### CROSS-REFERENCE TO RELATED APPLICATIONS

This patent application claims the benefit under 35 U.S.C. §119(e) of U.S. Provisional Patent Application No. 61/171,677, filed Apr. 22, 2009, which application is incorporated herein by reference.

### FIELD OF THE INVENTION

The present invention relates generally to the manufacture of ammonia borane, ammonia alkyl borane, or ammonia aryl borane, and more particularly to the manufacture of ammonia borane, ammonia alkyl borane, or ammonia aryl borane via an ambient temperature liquid ammonia process.

### BACKGROUND OF THE INVENTION

Ammonia borane, NH₃BH₃, has great potential for use as a key component in hydrogen storage fuels due to its stability and high gravimetric content of hydrogen. Ammonia borane is a solid at room temperature, stable in air and water and contains 190 g/kg (100-140 g/L) hydrogen (19.5 wt % hydrogen). Since even highly compressed hydrogen gas has insufficient volumetric density (40 g/L at 700 bar) to fuel even the most fuel-efficient automobiles three hundred miles, alternative hydrogen storage materials such as ammonia borane are currently of intense interest. Department of Energy (DOE) targets for hydrogen storage are 60 g/kg (45 g/L) for the year 2010, and that includes not just the material, but the entire storage system.

A highly efficient, low density, high hydrogen content material such as ammonia borane can meet these requirements. Nevertheless, solutions to the problems of large scale manufacture of ammonia borane have, to date, not been successfully addressed, in part due to the lack of suitable manufacturing methods to prepare ammonia borane.

Past efforts to prepare ammonia borane by the direct ammonolysis of diborane utilizing liquid ammonia have been shown to be unsuccessful. Such methods largely involved the direct reaction of diborane with ammonia through its addition to liquid ammonia at low temperatures. Typically, temperatures approximating −78° C. were used. Results showed that addition of diborane to a liquid ammonia reservoir that is maintained at −78° C. and ambient pressure results, rather, in the formation of the diammoniate of diborane according to the following equation (1) (See, e.g., Shore, S. G.; Boddeker, K. W. Inorg. Chem. 1964, 3, 914; and, Mayer, E. Inorg. Chem., 1972, 11, 866):

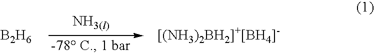

The diammoniate of diborane so produced is not stable at 25° C., either as a solid or in ether solution containing trace amounts of ammonia, and very slowly converts to NH₃BH₃ or a mixture of polymeric (NH₂BH₂)ₙ and NH₃BH₃, as shown in equations (2) and (3), respectively (See, e.g., Karlanlkar, A.; Aardahl, C.; Autrey, T.; Material Matters, Sigma-Aldrich, “Hydrogen Storage Materials,” 2007, 2 (2), 7; and, Shore, S. G.; Boddeker, K. W.; Patton, J. A. Inorg. Syn. 1967, 9, 4):

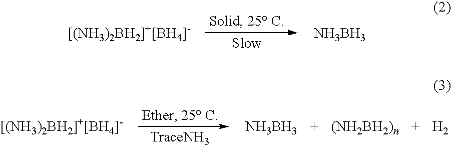

Conversion of [(NH₃)₂BH₂]⁺[BH₄]⁻ to pure NH₃BH₃ has, nevertheless, been shown to be facilitated by heating of the diammoniate at room temperature in an organic ether containing trace amounts of diborane, as shown in equation (4) (See, e.g., Mayer, E. Inorg. Chem. 1973, 12, 1954):

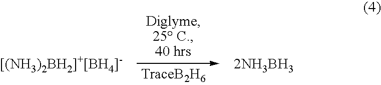

The reaction of equation (4) yields approximately 80-91% NH₃BH₃.

While some sequence of the above reactions do, indeed, lead to the preparation of ammonia borane, they involve first, the preparation and then isolation of the diammoniate of diborane, followed by a subsequent dissolution and heating step of the diammoniate salt in a relatively high boiling ether solvent for an extended period of time. Such a process is not feasible from a manufacturing standpoint.

In order to circumvent some of the problems associated with the above, other synthetic routes to ammonia borane have been developed. To date, ammonia borane has been successfully prepared on the laboratory scale utilizing two alternative synthetic routes to those described above: 1) the direct ammonolysis of Lewis Base adducts of borane in ether solvent using gaseous ammonia; and, 2) the decomposition of ammonium borohydride formed by the direct reaction of metal borohydride salts with ammonium halide salts. These methods are described below.

I. Ammonolysis of Lewis Base Borane Adducts.

The preparation of ammonia borane by the ammonolysis of Lewis Base adducts of borane most typically involves the condensation of diborane, B₂H₆, into an organic ether (to form a BH₃OR₂ coordination compound) followed by treatment of the ether solution of the coordination compound with gaseous ammonia at −78° C., as shown in equation (5) (See, e.g., Shore, S. G.; Boddeker, K. W. Inorg. Chem. 1964, 3, 914):

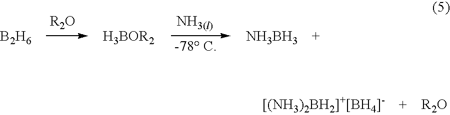

Ammonia borane yields vary from 45-60%; however, the diammoniate of diborane, constituting the remainder of the product, accounts for a large fraction of the total yield. As a consequence, one either suffers a low yield recovery of ammonia borane from the process, or is faced with a subsequent conversion step involving the diammoniate of borane, similar to the one described above using the direct ammonolysis approach.

II. Decomposition of NH₄⁺BH₄⁻.

It was originally anticipated that the decomposition of ammonium borohydride, NH₄⁺BH₄⁻ would provide an alternative synthetic route to NH₃BH₃. The by-product of this reaction is hydrogen gas. Indeed, NH₄⁺BH₄⁻ has been prepared via the reaction of Na⁺BH₄⁻ with NH₄⁺Cl⁻ in an organic solvent; however, the yields of ammonia borane from its decomposition have ranged from only 30% to up to 85%. (See, e.g., Shore, S. PhD thesis, University of Michigan, 1956; Shore, S. G.; Parry, R. W. J. Am. Chem. Soc., 1958, 80, 8; Ramachandran, P. V.; Gagare, P. D. Inorg. Chem., 2007, 9, 1831; and, Hu, M. G.; van Paasschen, J. M.; Geanangel, R. J. Inorg. Nucl. Chem., 1977, 39, 2147). Similar reactions have been performed using other metal borohydride salts in combination with a variety of alternative ammonium salts.

Although NH₄⁺BH₄⁻ is, itself, stable at −40° C. in liquid ammonia, it has recently been shown that NH₄⁺BH₄⁻ will yield NH₃BH₃ in near quantitative amounts when permitted to undergo decomposition upon warming from −78° C. to 25° C. in ether solvent while in the presence of liquid ammonia, NH₃, as shown in equation (6) (See, e.g., Heldebrant, D. J.; Karkamkar, A.; Linehan, J. C.; Autrey, T. Energy Environ. Sci., 2008, 1, 156-160):

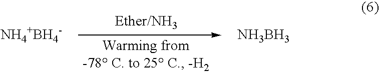

While such a method can be successfully employed to prepare ammonia borane without contamination with the diammoniate of diborane in a “one pot” procedure it is, nevertheless, multi-step and somewhat cumbersome to implement on a large scale. One is further faced with the issue of dealing with inflammable gaseous hydrogen by-product as the ammonia borane forms and the complications of dealing with salt by-products, such as [NH₃BH₂NH₃]⁺[Cl]⁻ and [NH₃BH₂NH₃]⁺[Br]⁻, since NH₄⁺BH₄⁻ is typically prepared by reacting the diammoniate of diborane with NH₄⁺Cl⁻ or NH₄⁺Br⁻, respectively.

Accordingly, there is a need for an improved method of manufacturing ammonia borane which can be scaled to large quantity production yields and performed at or near ambient temperature ranges. Heretofore, the known methods are insufficient for scaled production quantities and may not be performed at or near typical ambient temperature ranges.

### BRIEF SUMMARY OF THE INVENTION

The inventors of the instant invention serendipitously recognized that the reactivity discussed above tends to indicate several certain favored reaction pathways. The first pathway recognized is that low temperatures (such as those involved in a typical liquid ammonia ammonolysis preparation) appear to favor the formation of the diammoniate of diborane over the formation of ammonia borane. The second pathway recognized is that the conversion of the diammoniate of diborane to ammonia borane can be effected at ambient temperature and is expedited by its dissolution in ether solvents.

These observations led the inventors to realize that under the appropriate conditions, either: 1) the direct reaction of ammonia with diborane or a Lewis Base adduct of borane at temperatures approximating 25° C. in a solvent medium consisting of liquid anhydrous ammonia and an organic ether; or, 2) the decomposition of ammonium borohydride formed from the direct reaction of a metal borohydride with an ammonium salt at temperatures approximating 25° C. in a solvent medium consisting of liquid anhydrous ammonia and an organic ether, would lead directly to the high yield production of ammonia borane without a diammoniate of diborane contaminant.

The present invention broadly comprises a method of preparing an ammonia borane compound selected from the group consisting of: ammonia borane, ammonia alkyl borane, ammonia aryl borane and mixture thereof, the method including the steps of: a) incorporating a reaction mixture into a pressure vessel, the reaction mixture including anhydrous liquid ammonia and a boron containing compound that can react under pressure with the liquid ammonia to form the ammonia borane compound; and, b) causing the reaction mixture to warm from a first temperature greater than or equal to −33° C. to a second temperature under pressure to form the ammonia borane compound. In some embodiments, the first temperature is greater than or equal to −20° C., while in other embodiments, the first temperature is greater than or equal to −10° C. In yet other embodiments, the first temperature is greater than or equal to 0° C., while in still yet other embodiments, the first temperature is greater than or equal to +10° C.

In some embodiments, the present invention may further include the step of: c) removing residual anhydrous liquid ammonia from the reaction mixture. In other embodiments, the first temperature of the reaction mixture is increased to the second temperature via an exothermic reaction of the anhydrous liquid ammonia and the boron containing compound, via an external addition of heat energy or via a combination thereof.

In still yet other embodiments, the anhydrous liquid ammonia, the boron containing compound, or the anhydrous liquid ammonia and the boron containing compound are combined with an organic solvent prior to the step of incorporating the reaction mixture. In some of these embodiments, the organic solvent is an ether, while some of these embodiments the ether is selected from the group consisting of: tetrahydrofuran, glyme, diglyme, triglyme, diethyl ether, dibutyl ether, methyl ethyl ether, diethoxyethane and mixtures thereof. Furthermore, in some embodiments, the present invention includes the steps of: c) removing residual anhydrous liquid ammonia from the reaction mixture; and, d) removing the organic solvent from the reaction mixture.

In other embodiments, the boron containing compound is selected from the group consisting of: a borane species, ammonium borohydride, and mixtures thereof.

In some embodiments, the borane species is selected from the group consisting of: a diborane, a Lewis Base adduct of diborane, an alkyl borane, a Lewis Base adduct of an alkyl borane, an aryl borane, a Lewis Base adduct of an aryl borane, an ether adduct of borane, an ether adduct of alkyl borane, an ether adduct of aryl borane, a sulfide adduct of borane, a sulfide adduct of alkyl borane, a sulfide adduct of aryl borane, an amine adduct of borane, an amine adduct of alkyl borane, an amine adduct of aryl borane, and mixtures thereof. In some of these embodiments, the borane species is a diborane, while in others of these embodiments, the borane species is a borane tetrahydrofuran complex, in yet others of these embodiments, the borane species is dimethylsulfide borane and in still yet others of these embodiments, the borane species is diethylaniline borane, 2-picoline borane, pyridine borane, tertbutylamine borane, and triethylamine borane, or mixtures thereof.

In some embodiments, the ammonium borohydride is formed from a metal borohydride salt and an ammonium salt. In some of these embodiments, the metal borohydride salt comprises an alkali metal, while in some of these embodiments the alkali metal is selected from the group consisting of: lithium, sodium and potassium, and in yet others of these embodiments, the alkali metal is sodium. In some embodiments, the ammonium salt is an ammonium halide salt, while in some of these embodiments, the ammonium halide salt is selected from the group consisting of: ammonium chloride, ammonium bromide, ammonium iodide and combinations thereof, and in yet others of these embodiments, the ammonium halide salt is ammonium chloride.

In other embodiments, the ammonium borohydride is formed in situ from a metal borohydride salt and an ammonium salt. In still yet other embodiments, the ammonium borohydride is formed ex situ from a metal borohydride salt and an ammonium salt. It should be appreciated that in situ is intended to mean that the ammonium borohydride is formed within the reaction mixture, while ex situ is intended to mean that the ammonium borohydride is formed separate from the reaction mixture and subsequently incorporated with liquid ammonia to form the reaction mixture.

These and other objects and advantages of the present invention will be readily appreciable from the following description of preferred embodiments of the invention and from the accompanying drawings and claims.

### DETAILED DESCRIPTION OF THE INVENTION

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

It has now been discovered that the reaction of diborane or a Lewis Base adduct of borane and liquid ammonia at elevated temperatures, either with or without added ether solvent, results in the high yield formation of NH₃BH₃ with minimal formation of the diammoniate of diborane contaminant. Examples of suitable ether solvents include, but are not limited to, tetrahydrofuran, glyme (also known as dimethoxyethane), diglyme (also known as 2-methoxyethyl ether), triglyme, diethyl ether, dibutyl ether, methyl ethyl ether, diethoxyethane, or mixtures thereof.

Similarly, the reaction of an alkyl or aryl substituted borane or the Lewis Base adduct of an alkyl or aryl substituted borane with liquid ammonia at elevated temperatures, either with or without added ether solvent, results in the high yield formation of the corresponding ammonia adduct of the alkyl or aryl substituted borane, again with minimal formation of any diammoniate contaminant.

It has further been discovered that when ammonium borohydride is prepared by the direct reaction of a metal borohydride with an ammonium salt in liquid ammonia at elevated temperatures, the decomposition of the ammonium borohydride at those temperatures also results in the high yield production of ammonia borane, also with minimal formation of the diammoniate of diborane contaminant. Suitable borohydrides anions may be BH₄⁻ or a borohydride anion in which one or more of the hydrogen atoms is substituted by an alkyl or aryl radical. Suitable ammonium cations may be NH₄⁺ or an ammonium cation in which one or more of the hydrogen atoms is substituted by an alkyl or aryl radical. The metal cation, contained in the metal borohydride reactant as well as the organic or inorganic anion contained in the ammonium salt reactant is of less importance. However, it should be appreciated that metal cations that are alkali or alkaline metals are preferred, and ammonium salt anions that are halides such as chloride, or organic anions such as acetate, are preferred.

“Elevated temperatures” is intended to mean a temperature of −20° C. or above, preferably −10° C. or above, more preferably 0° C. or above, and most preferably 10° C. or above. At these temperatures, under atmospheric pressure, ammonia is a gas; however, containment in a pressure vessel enables the ammonia reactant to be retained in its liquid form. It should be appreciated that higher temperatures are preferred, since such higher temperatures favor the formation of NH₃BH₃ over the diammoniate of diborane, while lower temperatures favor the formation of the diammoniate of diborane over the formation of NH₃BH₃.

In a preferred embodiment of the current invention a borane, also known as a borane species, such as, a diborane, a Lewis Base adduct of diborane, an alkyl borane, a Lewis Base adduct of an alkyl borane, an aryl borane, a Lewis Base adduct of an aryl borane, or a mixture thereof, is injected directly into a reservoir of liquid ammonia contained in a pressure vessel that is initially held at low temperature (0° C. or below) and atmospheric pressure (1 bar). It should be appreciated that the present invention may also include borane species such as an ether adduct of borane, an ether adduct of an alkyl borane, an ether adduct of an aryl borane, or mixtures thereof. An example of such a borane species includes a borane tetrahydrofuran complex. Furthermore, the present invention may also include borane species such as a sulfide adduct of borane, a sulfide adduct of alkyl borane, a sulfide adduct of aryl borane, or mixtures thereof. An example of such a borane species includes dimethylsulfide borane. Moreover, the present invention may also include borane species such as an amine adduct of borane, an amine adduct of alkyl borane, an amine adduct of aryl borane, or mixtures thereof. Example of such borane species include diethylaniline borane, 2-picoline borane, pyridine borane, tertbutylamine borane, triethylamine borane or mixtures thereof.

In this preferred embodiment, the borane species is first added to an organic solvent, such as an ether, and the ether solution of the borane species is then injected into the anhydrous liquid ammonia. The heat generated from the exothermic nature of the reaction of the borane derivative with the liquid ammonia then warms the reaction mixture to the elevated temperatures (10° C. or above) at which the reaction to produce ammonia borane occurs. Alternatively, external heat can be provided if desired, or the reaction vessel can be allowed to warm to ambient temperature over time. The pressure generated upon such warming (10 bars or above) is contained in the closed pressure reactor vessel so that the ammonia present can then be maintained in the liquid phase.

An important feature of the current invention is that at the elevated temperatures used in the practice of the instant invention, any of the diammonate of diborane, [(NH₃)₂BH₂]⁺[BH₄]⁻ that might initially be formed readily disproportionates, in the presence of the warm liquid ammonia or warm liquid ammonia/ether mixture, to yield ammonia borane. In the preferred embodiment, an organic ether solvent is added to the reaction mixture.

Upon completion of a reaction performed in the manner of the preferred embodiment described above, the solution of ammonia borane product in the mixed ether/liquid ammonia solvent is removed from the pressure reactor and the liquid ammonia solvent is stripped from the mixture at elevated temperature and/or reduced pressure, while allowing the higher boiling ether solvent to remain. Upon evaporation of the liquid ammonia, any diammoniate salt contaminant which remained in the reaction mixture precipitates from the remaining ether solution of ammonia borane, leaving an ether solution of purified ammonia borane. This solution can then be stripped of ether solvent to yield pure ammonia borane as a white powder.

In another embodiment of the current invention a metal borohydride salt such as sodium borohydride and an ammonium salt such as ammonium chloride are sequentially or simultaneously added to a reservoir of liquid ammonia contained in a pressure vessel that is initially at −33° C. and atmospheric pressure (1 bar). The heat generated from the exothermic nature of the metathesis reaction of the metal borohydride salt and the ammonium salt in the liquid ammonia warms the reaction mixture to the elevated temperature at which the reaction to produce ammonium borohydride occurs. Alternatively, external heat can be provided if desired. The pressure generated upon such warming (approx. 10 bars at 25° C.) is contained in the closed pressure reactor vessel so that the ammonia present can then be maintained in the liquid phase.

In a preferred embodiment, organic ether solvent is also added to the reaction mixture. In this preferred embodiment, an ammonium salt is used that is soluble in liquid ammonia and which reacts with the chosen metal borohydride to give a metal salt that is also soluble in liquid ammonia, but is insoluble or only sparingly soluble in organic ethers. A notable example is the salt couple NH₄Cl and NaCl. At −10° C., for example, NH₄Cl has a solubility of 32 wt % in liquid ammonia. At −10° C., NaCl has a solubility of 14 wt % in liquid ammonia, but largely insoluble in ether solvents such as THF. At higher temperatures these solubilities in liquid ammonia are appreciably higher. The following reaction employing sodium borohydride and ammonium chloride in liquid ammonia/tetrahydrofuran solvent at 10° C. and 4 bars pressure thus represents one embodiment of the instant invention, as shown in equations (7) and (8):

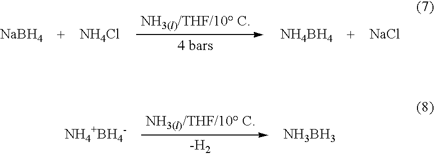

In this example, once the reaction is complete, the liquid ammonia is evaporated to precipitate the sodium chloride from the remaining ether solvent, and the evaporated ammonia is then recondensed for future use. Upon removal of the ether solvent, the product ammonia borane remains as a solid powder.

### EXAMPLES

### Example 1

### Preparation of Ammonia Borane by the Reaction of the THF Adduct of Borane with Liquid Ammonia at 5° C.

A 6 liter pressure reactor was charged with 3.5 liters of commercial grade anhydrous liquid ammonia. The ammonia was transferred directly from the cylinder without additional purification. The pressure reactor was equipped with a thermocouple and pressure gauge. For mixing, a pump around loop withdrew liquid from the bottom of the reactor and injected into the upper portion of the reactor below the liquid ammonia surface.

Borane-tetrahydrofuran (1.0 L, 1.0 M in THF with 5 mmol NaBH₄) (Alfa Aesar, Ward Hill, Mass., Lot #B13T015) was stored in a stainless steel vessel under 150 psi of nitrogen, a pressure greater than the anticipated pressure of the reactor. The borane-tetrahydrofuran solution was injected slowly into the reactor that was initially at a temperature of 4° C. over a 6 minute and 30 second time period. The heat of the reaction caused the reaction temperature to rise to 7° C. and the pressure in the reactor increased from 58 psig to 85 psig, reflecting the pressure generated from the higher temperature along with back pressure resulting from the injection. Table 1 below includes the change of temperature and pressure with respect to time.

TABLE 1

| Injection Time (min) | Temperature (° C.) | Pressure (psig) |
|---|---|---|
| 0 | 4.2 | 58 |
| 2 | 4.8 | 59 |
| 4 | 5.9 | 60 |
| 6 | 7 | 61 |
| 6.5 | | 85 |
| 120 (after injection | 12.4 | 101 |
| complete) | | |

Following the addition of the borane-tetrahydrofuran reactant, the reaction mixture was stirred for an additional 2 hours and then allowed to equilibrate in the reactor for 1 hour. The reaction mixture was collected and the ammonia removed first by evaporation and second by bubbling N₂ through the remaining reaction mixture. As the ammonia was being removed a white precipitate formed, which was filtered and collected (7.25 grams, 21% of total product). Removal of the THF from the filtrate gave 26.8 grams (79% of total product) of ammonia borane as a white solid. The total calculated yield of 109% (based on a theoretical yield of 31.0 grams of product) reflected some residual tetrahydrofuran that was subsequently removed upon exposure to high vacuum.

### Example 2

### Preparation of Ammonia Borane by the Reaction of Sodium Borohydride with Ammonium Chloride in Liquid Ammonia at 5° C.

A 6 liter pressure reactor is initially charged with 38 grams of NaBH₄ powder and 53 grams of NH₄Cl powder. The reactor is then further charged 3.5 liters of commercial grade anhydrous liquid ammonia at 5° C. The ammonia is transferred directly from the cylinder without additional purification. The reactor is further charged with 1.0 liters of tetrahydrofuran. The pressure reactor is equipped with a thermometer and pressure gauge.

Once charged with the reactants and ammonia/tetrahydrofuran solvent mixture, the pressure reactor is then sealed and the reaction mixture is stirred for an additional 1 hour, at which time the pressure in the reactor increases from 58 psig due to the evolution of hydrogen by-product. The reactor is allowed to equilibrate for 30 minutes, at which time the reactor is vented of hydrogen gas by-product to restore the vessel to atmospheric pressure. The reaction mixture is collected and the ammonia removed. As the ammonia is removed, a white precipitate of NaCl forms, which is filtered and collected resulting in a high yield of ammonia borane. Removal of the THF from the filtrate also provides a high yield of ammonia borane as a white solid. The evaporated ammonia is condensed for reuse.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A method of preparing an ammonia borane compound selected from the group consisting of: ammonia borane, ammonia alkyl borane, ammonia aryl borane and mixtures thereof, the method comprising the steps of:
a) incorporating a reaction mixture into a pressure vessel, the reaction mixture comprising anhydrous liquid ammonia and a boron containing compound that can react under pressure with the liquid ammonia to form the ammonia borane compound; and,
b) causing the reaction mixture to warm from a first temperature greater than or equal to −33° C. to a second temperature under pressure to form the ammonia borane compound.

2. The method of claim 1 wherein the first temperature is greater than or equal to −20° C.

3. The method of claim 1 wherein the first temperature is greater than or equal to −10° C.

4. The method of claim 1 wherein the first temperature is greater than or equal to 0° C.

5. The method of claim 1 wherein the first temperature is greater than or equal to +10° C.

6. The method of claim 1 further comprising the step of:
c) removing residual anhydrous liquid ammonia from the reaction mixture.

7. The method of claim 1 wherein the first temperature of the reaction mixture is increased to the second temperature via an exothermic reaction of the anhydrous liquid ammonia and the boron containing compound, via an external addition of heat energy or via a combination thereof.

8. The method of claim 1 wherein the anhydrous liquid ammonia, the boron containing compound or the anhydrous liquid ammonia and the boron containing compound are combined with an organic solvent prior to the step of incorporating the reaction mixture.

9. The method of claim 8 wherein the organic solvent is an ether.

10. The method of claim 9 wherein the ether is selected from the group consisting of: tetrahydrofuran, glyme, diglyme, triglyme, diethyl ether, dibutyl ether, methyl ethyl ether, diethoxyethane and mixtures thereof.

11. The method of claim 8 further comprising the steps of:
c) removing residual anhydrous liquid ammonia from the reaction mixture; and,
d) removing the organic solvent from the reaction mixture.

12. The method of claim 1 wherein the boron containing compound is selected from the group consisting of: a borane species, ammonium borohydride and mixtures thereof.

13. The method of claim 12 wherein the borane species is selected from the group consisting of: a diborane, a Lewis Base adduct of diborane, an alkyl borane, a Lewis Base adduct of an alkyl borane, an aryl borane, a Lewis Base adduct of an aryl borane, an ether adduct of borane, an ether adduct of alkyl borane, an ether adduct of aryl borane, a sulfide adduct of borane, a sulfide adduct of alkyl borane, a sulfide adduct of aryl borane, an amine adduct of borane, an amine adduct of alkyl borane, an amine adduct of aryl borane, and mixtures thereof.

14. The method of claim 13 wherein the borane species is a diborane.

15. The method of claim 13 wherein the borane species is a borane tetrahydrofuran complex.

16. The method of claim 13 wherein the borane species is dimethylsulfide borane.

17. The method of claim 13 wherein the borane species is diethylaniline borane, 2-picoline borane, pyridine borane, tertbutylamine borane, and triethylamine borane, or mixtures thereof.

18. The method of claim 12 wherein the ammonium borohydride is formed from a metal borohydride salt and an ammonium salt.

19. The method of claim 18 wherein the metal borohydride salt comprises an alkali metal.

20. The method of claim 19 wherein the alkali metal is selected from the group consisting of: lithium, sodium and potassium.

21. The method of claim 20 wherein the alkali metal is sodium.

22. The method of claim 18 wherein the ammonium salt is an ammonium halide salt.

23. The method of claim 22 wherein the ammonium halide salt is selected from the group consisting of: ammonium chloride, ammonium bromide, ammonium iodide and combinations thereof.

24. The method of claim 22 wherein the ammonium halide salt is ammonium chloride.

25. The method of claim 12 wherein the ammonium borohydride is formed in situ from a metal borohydride salt and an ammonium salt.

26. The method of claim 12 wherein the ammonium borohydride is formed ex situ from a metal borohydride salt and an ammonium salt.
